(19) United States
(12) Patent Application Publication
(10) Pub. No.: US 2024/0368778 A1
(43) Pub. Date: Nov. 7, 2024

(54) METHOD AND APPARATUS FOR CONTROLLING TORQUE IN A WIND TURBINE GENERATOR

(71) Applicant: VESTAS WIND SYSTEMS A/S, Aarhus N (DK)

(72) Inventors: Mie Elmholm BIRKBAK, Sabro (DK); Anders TUXEN, Risskov (DK)

(21) Appl. No.: 18/573,250

(22) PCT Filed: Jun. 21, 2022
(86) PCT No.: PCT/DK2022/050137

§ 371 Date: Dec. 21, 2023

(30) Foreign Application Priority Data
Jun. 21, 2021 (DK) PA202170317

(51) Int. Cl. C25B 9/65; C25B 9/70; F03D 9/25; F03D 13/20; H02K 7/116; H02K 7/18; H02K 11/00; H02K 11/04

(52) U.S. Cl. CPC C25B 9/65; C25B 9/70; F03D 9/25; F03D 13/201; H02K 7/116; H02K 7/1838; H02K 11/0094; H02K 11/04; F05B 2220/706

(57) ABSTRACT

A wind turbine generator is connected to a rectifier which is directly DC coupled to one or more electrolysers. The, or each, electrolyser comprises a plurality of electrolysis cells arranged in one or more stacks, each electrolysis cell comprising a pair of electrodes, and each stack of electrolysis cells comprising at a plurality of electrical connectors. Each electrical connector is in electrical contact with an electrode of an electrolysis cell. The electrical connectors are electrically connectable to the rectifier by a network of selectively operable electrical conductors which are configured so that some or all of the electrolysis cells are operable in dependence on the operative condition of the selectively operable electrical conductors. A method for controlling torque in a wind turbine generator comprising controlling the operation of the selectively operable electrical conductors in dependence on a generator output characteristic.

### TECHNICAL FIELD

The present disclosure relates to a method and apparatus for controlling torque in a wind turbine generator. In particular, the present disclosure relates to a method and apparatus for controlling torque in a wind turbine generator by selective operation of locally situated electrolysis cells.

### BACKGROUND

It has long been known that hydrogen is a highly effective energy carrier which results in no CO₂ emissions when energy is released. It can be readily stored and transported making it a truly viable alternative to fossil fuels such as petrol and diesel. However, hydrogen production via water electrolysis, requires a tremendous amount of electricity thereby potentially reducing the positive environmental impact of moving to hydrogen fuel.

Hydrogen produced by renewable energy sources such as wind or solar power is the environmental ideal since no fossil fuels are used in its production. Hydrogen produced in this way is known as green hydrogen. However, because wind and solar power production is dependent on ever changing environmental conditions, it is difficult in practice to produce hydrogen efficiently from these power sources. During electrolysis, the hydrogen may travel opposite of the intended flow and into the oxygen stream. This process is known as hydrogen cross-over. Particularly when the power available to the electrolyser is low (such as below about 15% nominal power of the electrolyser) the product flow rates may be so low that hydrogen cross-over potentially may result in an explosive gas mixture being formed. This is a safety hazard which clearly cannot be tolerated, so in practice electrolysers are not operated at low loads meaning that potentially useful green energy is not able to be used to produce green hydrogen. It should be observed that the minimum acceptable nominal power (below which hydrogen cross-over becomes unacceptable) varies a lot, and depend for example on type of electrolyser technology, electrode efficiency, separator material, electrolyte choice, flowrates of pumps (if any), what mode and pressure the electrolyser is run under (dry-wet, wet-wet or SOEC).

A particularly efficient arrangement is to connect an electrolyser directly to the generator of a wind turbine generator in a DC-coupled connection. Such an arrangement can potentially provide many advantages in terms of lower cost of convertor and improved electrical efficiency as fewer power electronics need to be used. However, a major challenge to the DC-coupled concept is that the when the voltage over the electrolyser is low, the current through the electrolyser will be drastically reduced and as a result the torque in the generator will drop significantly. As is well known in the art, sudden low generator torque is to be avoided as it leads to unbalanced loads, unwanted noise and improper control of rotor RPM. This presents a large challenge to the DC-coupled concept at low wind turbine rotor RPM.

It is against this background that the present invention has been developed.

### SUMMARY OF THE INVENTION

The present invention provides a wind turbine comprising:
a tower which supports a nacelle, wherein the nacelle supports a rotor assembly comprising a rotor hub and a plurality of rotor blades;
an electrical generator located in the nacelle, wherein the electrical generator is configured to be driven by the rotor assembly;
a rectifier electrically connected to the generator; and
a plurality of electrolysis cells arranged in one or more stacks, wherein each electrolysis cell comprises a pair of electrodes, and wherein each stack of electrolysis cells comprises at a plurality of electrical connectors each of which is in electrical contact with an electrode of an electrolysis cell,
wherein the electrical connectors are electrically connectable to the rectifier by a network of selectively operable electrical conductors which are configured so that some or all of the electrolysis cells are operable in dependence on the operative condition of the selectively operable electrical conductors.

The wind turbine of the present invention is advantageous as the electrolyser (or electrolysers) are located at the site of the wind turbine and directly coupled to the rectifier thereby reducing transmission power losses between the rectifier and the electrolyser(s).

Optionally the electrical connectors of at least one stack of electrolysis cells are configured so that electrical current may enter the stack at a plurality of locations.

This is advantageous as the number of electrolysis cells in use at any one time can be selected so the that the operation of the electrolyser(s) may be optimised to better suit the power available from the generator. This facilitates operation of at least some of the electrolysis cells when the available power is low. In addition, the current through the electrolyser(s) can be better controlled thereby allowing better torque control of the generator in low power situations and during start-up and power down.

The electrical connectors of at least one stack of electrolysis cells may optionally be configured so that electrical current may exit the stack at a plurality of locations.

Two of the electrical connectors (preferably two connectors of the same stack) may be connected by a bypass line, such as a selectively operable electrical conductor bypass line, so that electrical current may bypass at least one of the plurality of electrolysis cells, such as at least one of the plurality of electrolysis cells arranged between the two electrical connectors. This allows greater operational flexibility as the electrolysis cells in use at any one time may be varied depending not only on the power available to the electrolyser, but also on the condition or total usage time of the electrolysis cells. This helps to avoid over use of any one section of the electrolyser.

The wind turbine may comprise a single stack of electrolysis cells to provide optimal packaging efficiency.

In one example the selective operability of the network of selectively operable electrical conductors is controlled by one or more switches. This is convenient as the switches may be readily operated to select which part of the electrolyser is in use at any one time.

Optionally the one or more switches are remotely controllable so that an operator may be located remote from the wind turbine bled site itself.

The one or more switches are optionally configured to be controlled by an electronic controller so that control of the sections of the electrolyser in use at any one time may be automated.

The wind turbine may comprise a stack of electrolysis cells located in the nacelle, a position which allows the electrolysis cells to be placed as close as possible to the generator to reduce transmission losses.

In one example the stack or stacks of electrolysis cells may be located in the tower or on an external platform for ease of access, maintenance and installation.

In another aspect, the present invention provides a method of controlling torque in a wind turbine generator, the method comprising:
operating a wind turbine configured as described above;
determining an output characteristic of the generator; and
controlling the operation of the selectively operable electrical conductors in dependence on the determined generator output characteristic in order to operate some or all of the electrolysis cells.

Optionally the selectively operable electrical conductors may be controlled to operate all of the electrolysis cells when the generator output characteristic meets or exceeds a predetermined criteria.

Controlling the selectively operable electrical conductors may optionally comprise controlling the selectively operable electrical conductors so as to operate a first number of the electrolysis cells when the generator output characteristic meets or exceeds a first predetermined criteria, and controlling the selectively operable electrical conductors so as to operate a second number of the electrolysis cells when the generator output characteristic meets or exceeds a second predetermined criteria, wherein the second number of electrolysis cells is greater than the first number of electrolysis cells, and wherein the second predetermined criteria corresponds to a higher generator power output than the first predetermined criteria.

The total operational time or another wear characteristic for each electrolysis cell, or for a set of electrolysis cells, may be determined and operation of the selection of the electrolysis cells may be based on an algorithm configured to preferentially operate electrolysis cells, or sets of electrolysis cells, with the lowest total operational time or other wear characteristic.

Alternatively or additionally, the internal resistance of each electrolysis cell, or a set of electrolysis cells, may be determined and operation of the selection of the electrolysis cells may be based on an algorithm configured to preferentially operate electrolysis cells, or sets of electrolysis cells, with the lowest internal resistance at a given current point of operation.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described, by way of example only, with reference to the accompanying drawings, in which:

FIG. 1 shows a schematic view of a wind turbine;

FIG. 2 shows a schematic view of the internal components of the nacelle of the wind turbine;

FIG. 3 shows a schematic diagram of the electrical connections between the wind turbine generator and an electrolyser;

FIG. 4 shows a schematic diagram of an alternative arrangement of electrical connections between the wind turbine generator and an electrolyser;

FIG. 5 shows a schematic diagram of a further alternative arrangement of electrical connections between the wind turbine generator and an electrolyser;

FIG. 6 shows an alternative arrangement to the one shown in FIG. 4; and

FIG. 7 shows an alternative arrangement to the one shown in FIG. 2.

### DETAILED DESCRIPTION

The following detailed description refers to the accompanying drawings that show, by way of illustration, specific details and embodiments in which the invention may be practiced. These embodiments are described in sufficient detail to enable those of ordinary skill in the art to practice the invention. Other embodiments may be utilised, and structural changes may be made without departing from the scope of the invention as defined in the appended claims.

Modern horizontal axis wind turbines typically comprise a tower which supports a nacelle upon which a rotor is mounted. Wind turbines situated offshore may also comprise a transition piece and an external platform located near the base of the tower.

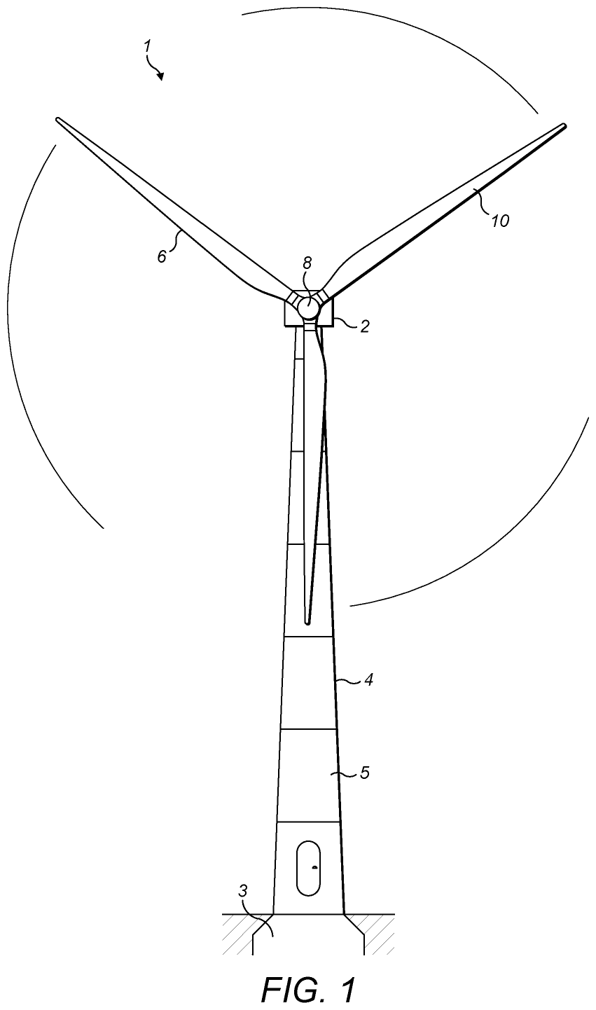

FIG. 1 shows a schematic view of a wind turbine 1. The wind turbine 1 includes a nacelle 2 that is supported on a generally vertical tower 4, which itself comprises a plurality of tower sections 5. The nacelle 2 houses a number of functional components, including a gearbox 11 and a generator 12 (not shown in FIG. 1), and supports a main rotor arrangement 6. The main rotor arrangement 6 comprises a hub 8 and a plurality of wind turbine blades 10 connected to the hub 8. In this example, the wind turbine 1 comprises three wind turbine blades 10.

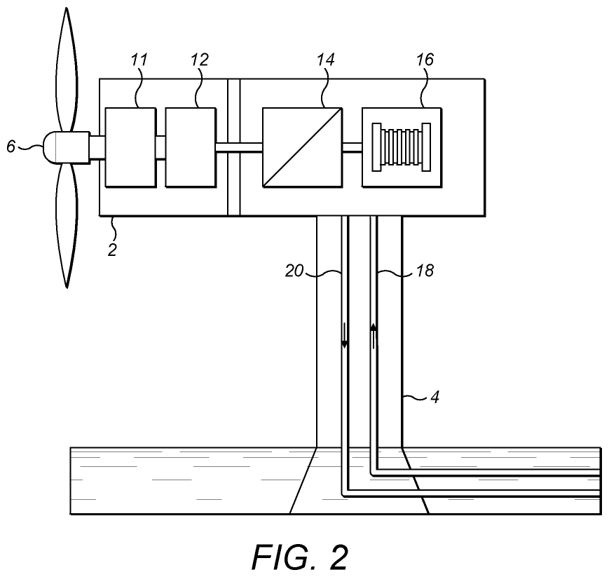

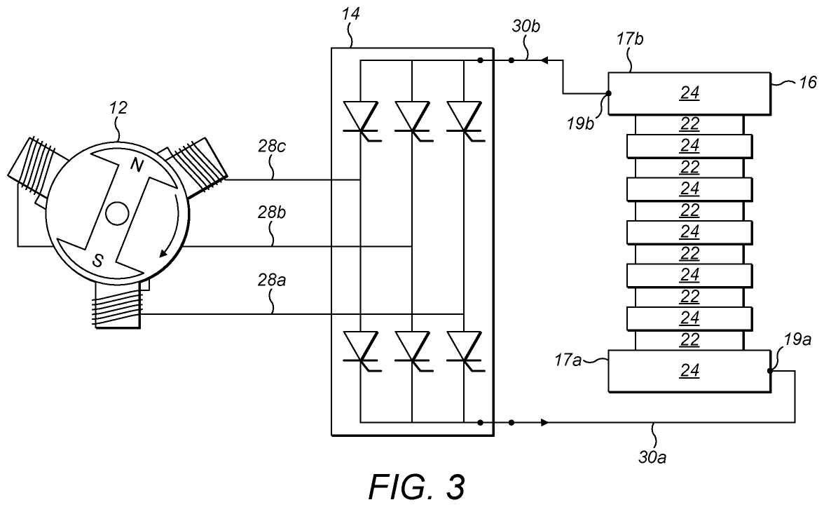

FIG. 2 shows a schematic view of the nacelle 2 and rotor 6 of the wind turbine 1. The nacelle 2 houses a gear box 11 which is connected to and driven by the rotor 6. The gear box 11 is in turn connected to a generator 12. The generator 12 comprises a number of coils, here illustrated by three coils (see FIG. 3), such that the electrical output of the generator is a three-phase output. It will be understood by those skilled in the art that the gear box 11 may be omitted such that the generator 12 is driven directly by the rotor 6. The generator 12 is connected to an AC/DC convertor 14 which is coupled to an electrolyser 16 by a direct DC-coupling.

Water is supplied to the electrolyser 16 via a pipe 18 which passes through the inside of the tower 4, and hydrogen gas produced by the electrolyser 16 is conveyed to a storage facility via pipe 20 which passes through the inside of the tower 4. In an alternative example one or both of the pipes 18, 20 may pass along the outside of the tower 4. An additional pipe (not shown) may be provided to convey oxygen produced by the electrolyser 16 to a storage facility. The hydrogen and/or oxygen facilities may be located locally to the wind turbine 1, or may be located at a separate facility remote from the wind turbine 1.

FIG. 3 shows a schematic view of the electrolyser 16 and an example scheme for the electrical connections which may be made between the generator 12 and the electrolyser 16. The electrolyser 16 comprises a plurality of electrolysis cells 22 arranged in a stack. Each of the electrolysis cells 22 comprises a pair of electrodes 24 for carrying electrical current to and from the electrolysis cells 22 in use. The electrodes 24 located between adjacent cells 22 in the stack may be electrically connected to one another via an intermediate electrical conductor so that current may flow in series between the cells 22 in the stack. Alternatively, the electrodes 24 located between adjacent cells 22 may abut one another or may be integral with one another. The electrodes 24 of adjacent cell 22 in the stack may therefore be referred to as being electrically adjacent. The electrolyser 16 may be any suitable type of electrolyser known in the art such as a PEM electrolyser, an alkaline electrolyser or a solid oxide electrolyser.

The three phases of AC power produced by the generator 12 are connected to the convertor 14 by electrical conductors 28a, 28b, 28c, wherein each of the electrical conductors 28a, 28b, 28c is associated with a respective one of the three phases of the generator 12. The AC current from the generator 12 is converted to DC current by the convertor 14. In this example the convertor 14 is a three-phase rectifier. However, it will be understood that any suitable convertor may be used.

The electrolyser 16 comprises a first (or input) electrical connector 19a connected to the input electrode 24 of the electrolysis cell 22 located at a first end 17a of the electrolyser 16, and a second (or output) electrical connector 19b connected to the output electrode 24 of the electrolysis cell 22 located at a second end 17b of the electrolyser 16. The output of the convertor 14 is connected across the electrolyser 16 by a pair of electrical conductors 30a, 30b. A first one of the pair of electrical conductors 30a is connected to the first electrical connector 19a and the second of the pair of electrical conductors 30b is connected to the second electrical connector 19b.

In use, when the wind turbine 1 is operational such that the generator 12 is delivering power to the electrolyser 16, current to flows from the first end 17a to the second end 17b of the electrolyser 16 thereby causing the electrolyser to produce hydrogen and oxygen gas products. An isolation switch (not shown) may be included in either one of the electrical conductors 30a, 30b in order to electrically isolate the electrolyser 16 from the power supply. This might be needed, for example, when the power available from the generator 12 to the electrolyser 16 is low (for example, below about 15% of the rated maximum nominal load of the electrolyser 16) such that hydrogen cross-over becomes a risk. The isolation switch may be a mechanical or electronic switch.

The provision of an electrical connection across the full length of the electrolyser 16 is well known and is appropriate and effective for stable power supplies which do not vary with environmental conditions, and which do not require close impedance matching to stabilise the torque of a large rotating mass. The arrangement shown in FIG. 3 allows for a simple balance of operation between the wind turbine 1 and the electrolyser 16. However, this arrangement does not allow for operation of the electrolyser 16 during low power output operation of the wind turbine 1, and does not allow for stabilisation of the rotor torque at low RPM.

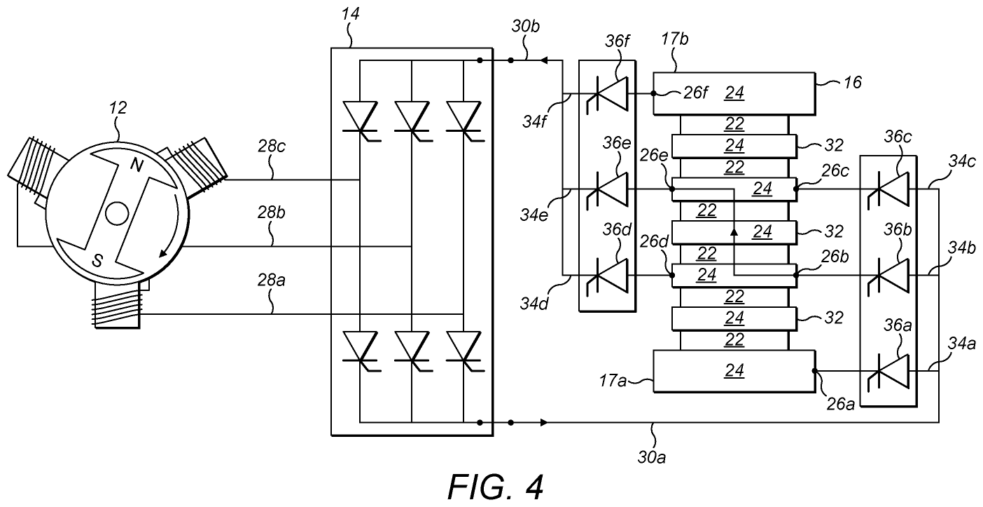

FIG. 4 shows a schematic view of an alternative electrical connection scheme between the electrolyser 16 and the generator 12. Like reference numerals have been used to indicate like features.

As above, the electrolyser 16 comprises a plurality of electrolysis cells 22 arranged in a stack.

The electrolyser 16 comprises a plurality of electrical connectors 26a, 26b, 26c, 26d, 26e, 26f which are connected to selected electrodes 24 of the electrolysis cells 22 forming the stack.

The first electrical connector 26a is connected to the input electrode 24 of the electrolysis cell 22 located at a first end 17a of the electrolyser 16, and the sixth electrical connector 26f is connected to the output electrode 24 of the electrolysis cell 22 located at a second end 17b of the electrolyser 16. The second and fourth electrical connectors 26b, 26d are connected to a first pair of electrically adjacent electrodes (which may be integral) part way along the stack of electrolysis cells 22, and the third and fifth electrical connectors 26c, 26e are connected to a second pair of electrically adjacent electrodes (which may be integral) a further part way along the stack of electrolysis cells 22. Thus, the electrolyser 16 may be split into three independently operable sections 32 depending on how the electrical connections to the electrolyser 16 are made.

The three phases of AC power produced by the generator 12 are connected to the convertor 14 by electrical conductors 28a, 28b, 28c, wherein each of the electrical conductors 28a, 28b, 28c is associated with a respective one of the three phases of the generator 12. The AC current from the generator 12 is converted to DC current by the convertor 14.

The output of the convertor 14 is connected across the electrolyser 16 by the pair of electrical conductors 30a, 30b. A first one of the pair of electrical conductors 30a is connected to three branch electrical conductors 34a, 34b, 34c. Similarly, the second of the pair of electrical conductors 30b is connected to three branch electrical conductors 34d, 34e, 34f. Each of the branch electrical conductors 34a, 34b, 34c, 34d, 34e, 34f is selectively connectable to an electrode 24 of the electrolyser 16 via thyristors 36a, 36b, 36c, 36d, 36e, 36f.

The first branch conductor 34a is connected to the first electrical connector 26a via thyristor 36a. Similarly, the sixth branch conductor 34f is connected to the sixth electrical connector 26f via thyristor 36a. The second and fourth branch conductors 34b, 34d are connected to the second and fourth electrical connectors 26b, 26d via thyristors 36b, 36d respectively, and the third and fifth branch conductors 34c, 34e are connected to the third and fifth electrical connectors 26c, 26e via thyristors 36c, 36e respectively.

As is well known in the art, current may only pass through a thyristor when a small control current is applied to the gate of the thyristor. Thus, the thyristors 36a, 36b, 36c, 36d, 36e, 36f constitute electronic switches which selectively allow electrical connection of the branch conductors 34a, 34b, 34c, 34d, 34e, 34f to the electrical connectors 26a, 26b, 26c, 26d, 26e, 26f of the electrolyser 16. It is therefore possible to selectively operate different parts of the electrolyser 16 in dependence on the amount of power being provided by the generator 12 as will be described in greater detail below.

In use, when the wind turbine 1 is operational such that the generator 12 is delivering power to the electrolyser 16, if the power provided by the generator 12 to the electrolyser 16 is at 15% of the rated maximum nominal load of the electrolyser 16 the entire length of the stack of electrolysis cells 22 forming the electrolyser 16 can be utilised. This is achieved by applying a control current to the gates of the first and sixth thyristors 36a, 36f to allow current to flow from the first end 17a to the second end 17b of the electrolyser 16 thereby utilising every electrolysis cell 22 in the stack. Alternatively, should the power available from the generator 12 be below 15% of the rated maximum nominal load of the electrolyser 16 the number of electrolysis cells 22 in use can be reduced by selective operation of the thyristors 36a to 36f.

For example, if the power available from the generator 12 is less than 15% but greater than or equal to 10% of the rated maximum nominal load of the electrolyser 16 a control current may be applied to the gates of the first and fifth thyristors 36a, 36e to allow current to flow from the first end 17a through the first and second sections 32 of the of the stack of cells 22 forming the electrolyser 16, so the operating cells 22 experience above the threshold, such as above about 15% rated power of the operating cells 22 even though the operating power is lower than the threshold of the whole electrolyser 16. Alternatively, a control current may be applied to the gates of the second and sixth thyristors 36b, 36f to allow current to flow through the second and third sections 32 of the of the stack of cells 22 forming the electrolyser 16.

If the power available from the generator 12 is less than 10% and greater than or equal to a cut-off minimum power of the rated maximum nominal load of the electrolyser 16 a control current may be applied to the gates of the first and fourth thyristors 36a, 36d to allow current to flow from the first end 17a through only the first section 32 of the of the stack of cells 22. Alternatively, a control current may be applied to the gates of the second and fifth thyristors 36b, 36e to allow current to flow through only the second section 32 of the of the stack of cells 22. In a further alternative, a control current may be applied to the gates of the third and sixth thyristors 36c, 36f to allow current to flow through only the third section 32 of the of the stack of cells 22.

The choice of which section(s) 32 of the electrolyser 16 to operate at any given time may be determined with reference to the usage history and/or a physical condition of the sections 32 of the cells 22 in the stack. For example, the section(s) 32 of the electrolyser may be selected for operation with reference to the total operational time of the section(s) 32 in question so that the total operational time is balanced between the available sections 32 as far as possible. This helps to prolong the operative life of the electrolyser 16 by preventing excessive wear in one or more sections 32 of the electrolyser 16 while leaving other sections 32 relatively unused. If one or more sections 32 of the electrolyser 16 become worn it is necessary to replace the entire electrolyser 16. It is therefore desirable to distribute the total operational time between the various sections 32 as evenly as possible.

Alternatively or additionally, the choice of which section(s) 32 of the electrolyser 16 to operate at any given time may be determined with reference to a physical condition of the sections 32 of the cells 22 in the stack such as internal resistance and/or the impedance measurement at a given polarization or given current set-point measured through a frequency range. For example, the internal resistance at a given polarization and/or current set-point of the sections 32 of the electrolyser 16 may be determined in real time or for example be determined via a database reference or based on modelling of the resistance and the section(s) 32 with the lowest internal resistance selected. If this selection method is used in combination with the total usage time selection method, priority may be given to one or other of the methods, or an algorithm may be used to determine which section(s) 32 of the electrolyser to use at any given point in time.

As mentioned in the introduction, when the voltage across the electrolyser 16 is low the current through the electrolyser is drastically reduced. As a result, the torque in the generator 12 drops significantly. By reducing the number of electrolysis cells 24 across which the voltage is applied the (series) internal resistance that the voltage ‘sees’ is reduced and hence the current can be maintained at a higher level. This has the dual benefit of allowing the generator torque to be maintained at an acceptable level, and allowing at least a part of the electrolyser 16 to continue to produce hydrogen in low load situations. The ability to control the torque in the generator 12 is also beneficial during start-up and power down of the generator 12 both of which typically result in low torque in the generator and may lead to undesirable instabilities in the operation of the wind turbine generator.

Because the thyristors 36a to 36f are electronic devices controlled by small gate currents it is possible to automate control of the operation of the electrolyser 16 by means of a programmable logic controller which may be programmed with a suitable algorithm to select which section(s) 32 of the electrolyser to operate at any given time. Alternatively, the selection of the section(s) 32 may be undertaken manually by an operator.

The thyristors 36a to 36f may be replaced by any other suitable switch such as an electromagnetic contact switch or the like. Alternatively, the thyristors 36a to 36f may be replaced by manually operated switches.

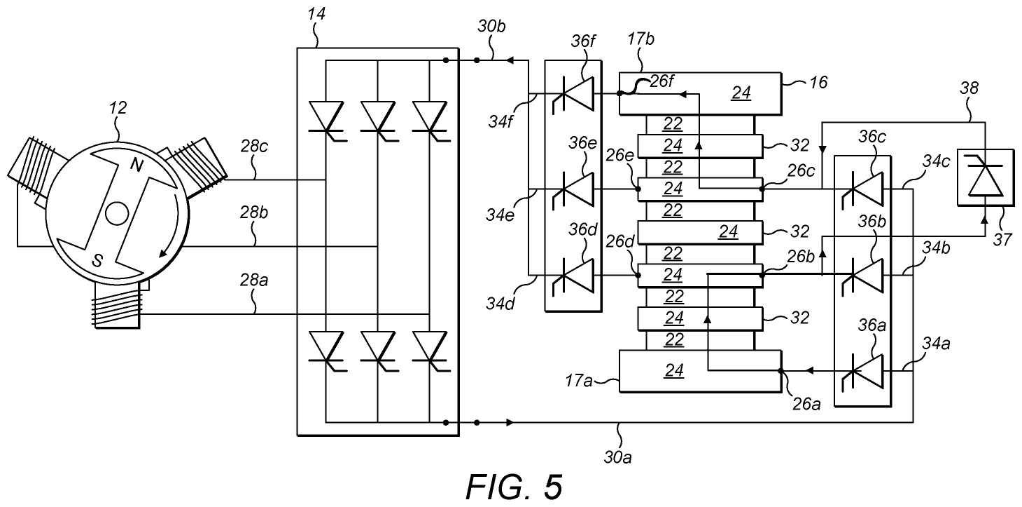

FIG. 5 shows a schematic view of a further alternative electrical connection scheme which is similar in all respects to the electrical connection scheme of FIG. 4 but which additionally has a bypass switch 37 provided within an electrical bypass line 38. The bypass line 38 is electrically connected to the second 26b and third 26c electrical connectors of the electrolyser 16 such that the mid-section 32 of the electrolyser 16 may be bypassed in use if required. In one example (as shown in FIG. 5), current indicated by arrow heads may be enter the stack via conductor 34a at connector 26a, exit at connector 26b via bypass line 38 and re-enter the stack at connector 26c to finally exit the stack at connector 26f via conductor 34f. This may be useful, for example, in cases in which the mid-section 32 has a fault and is therefore inoperable. The provision of such a selectively operable bypass line 38 therefore allows for continued operation of the electrolyser 16 if the mid-section becomes inoperable. Another example where bypassing of one or more electrolysis cells, sections of a stack or bypassing between cells of different stacks may be advantageous may be to preferentially operate electrolysis cells or sets of electrolysis cells with the lowest total operation time and hence provide a more even overall wear characteristic of the stack.

Another example where bypassing of one or more electrolysis cells, sections of a stack or bypassing between cells of different stacks may be advantageous is if one or more of the bypassed cells or connections are defect or become defect during the lifetime of the electrolyser. In this case, bypassing a defect cell, a defect stack section or a defect connection between cells, stack sections or stacks (particularly when arranged in series), allows for continued operation of the electrolyser with minimum loss of electrolyser capacity.

This is particularly advantageous if the electrolyser comprises a high number of cells, stacks or stack sections arranged in series and may greatly increase the redundancy of electrolyser capacity. The invention may therefore be particularly advantageous for wind turbines with a very high number of electrolysis cells arranged in series, such as comprising hundreds, thousands or even tens of thousands electrolysis cells arranged in series. The invention may also or alternatively be particularly advantageous for off-grid wind turbines (here off grid is understood as wind turbines without an electrical connection with capacity to export produced electricity, but optionally comprising an export pipe for electrolyser product) where a defect in the electrolyser may greatly reduce the production capacity of the wind turbine. With the wind turbine according to this aspect of the invention, the wind turbine may continue to operate with relatively small reduction in capacity until service of the electrolyser, and hence this is particularly advantageous for offshore wind turbines or wind turbines or off grid wind turbines. Situations where this may be relevant may for example be if an electrical connection between adjacent cells, adjacent stack sections or adjacent stacks are or become defect without gas or liquid separation being (significantly) affected.

Bypass line connections may also be utilized to preferentially operate electrolysis cells or sets of electrolysis cells with the lowest total operation time and hence provide a more even overall wear characteristic of the stack.

Bypass line connections may also be utilized to preferentially operate electrolysis cells or sets of electrolysis cells with the lowest internal resistance and hence provide a more efficient overall production of the stack.

The selectively operable bypass line may for example be controlled by one or more switches, such as a thyristor. Typically, the bypass line between two electrical connectors of one or more stacks will bypass one or more electrolysis cells, stack sections or even stacks arranged between the two electrical connectors.

In this example the bypass switch 37 is a thyristor. The skilled person will understand that the switch 37 may be any suitable type of mechanical or electronic switch which may be locally or remotely operated.

As will be clear to a person skilled in the art, the provision of a bypass line 38 to allow bypass of the mid-section of the electrolyser 16 is an example only. Furthermore, it will be clear that the example electrolysers 16 described in relation to FIGS. 3 to 5 may comprise any number of sections 32 with any number of bypass lines 38 and switches 37 as desired. In addition, each section 32 of the electrolyser 16 may comprise one or more electrolysis cells 22,

In the examples described above, the electrical conductors 28a, 28b, 28c, 30a, 30b, 34a, 34b, 34c, 34d, 34e, 34f, 38 comprise busbars. However, as will be understood by those skilled in the art, the electrical conductors may comprise any suitable electrical conductor such as cables or the like. Any combination of suitable electrical conductors may be used depending on the particular system design

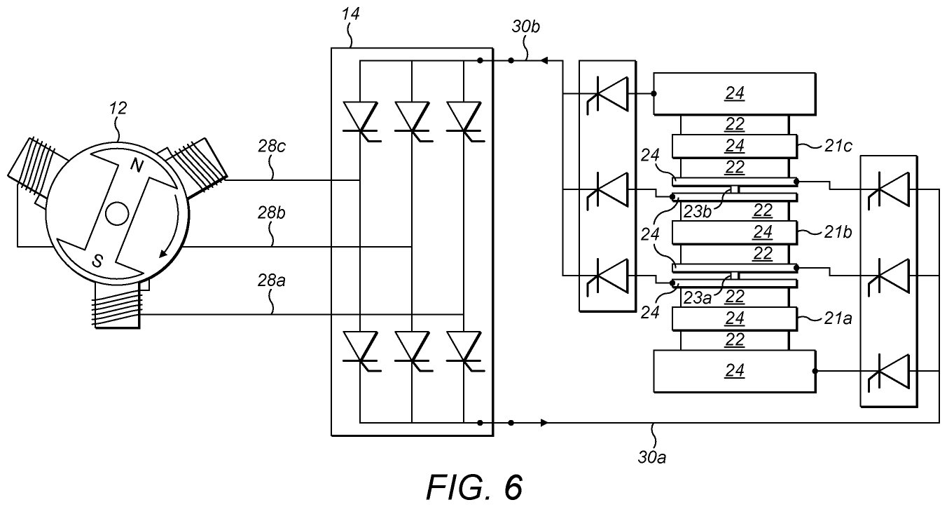

FIG. 6 shows another example of a hydrogen production system for use in a wind turbine 1 in which three electrolyser stacks 21a, 21b, 21c are provided in place of the single electrolyser 16 of FIGS. 3 to 5. In this example all three of the electrolysers 21a, 21b, 21c can be used when the power supply is above 15% of the of the rated maximum nominal load of the electrolysers 21a, 21b, 21c operating in series, or only one or two of the electrolysers 21a, 21b, 21c may be used in dependence on the available power in the same way as described above for the electrolyser 16. In this way it is achieved that the power experienced by each operating stack is above the threshold fraction of rated power, such as above about 15% rated power. To allow series operation of the electrolysers 21a, 21b, 21c, electrolyser 21a and electrolyser 21b are connected by an electrical conductor 23a, and electrolyser 21b and electrolyser 21c are connected by an electrical conductor 23b.

Each of the electrolysers 21a, 21b, 21c comprises a plurality of electrolysis cells 22. In an alternative example each of the three electrolysers 21a, 21b, 21c may be separated into two or more sections in the same way as described above for the electrolyser 16 described in relation to FIGS. 3 to 5 to give additional flexibility of operation and allow one or more sections (not shown) of the electrolysers 21a, 21b, 21c to operate above the threshold fraction of rated power even if the electrolyser is below the threshold.

It is not essential that the electrolyser 16 be electrically split into three sections 32, or that three electrolysers 21a, 21b, 21c be provided as an alternative to the single electrolyser 16. The above description is given as an example only. It will be clear to a person skilled in the art that the single electrolyser 16 may be split into any number of sections 32 as appropriate for a particular system design, or that any suitable number of separate electrolysers 21(a,b,c) may be used instead on a single electrolyser 16. In addition, it will be clear to a person skilled in the art that the plurality of separate electrolysers, if used, may themselves be electrically split into two or more sections as appropriate for a particular system design.

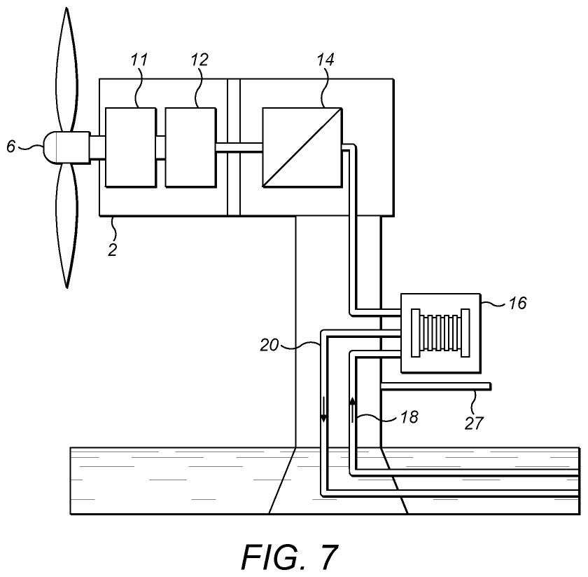

FIG. 7 shows an alternative wind turbine 1 arrangement in which the electrolyser 16 (or alternatively electrolysers 21a, 21b, 21c) is located on a platform 27 located outside the wind turbine 1. In a further alternative (not shown) the electrolyser 16 (or alternatively electrolysers 21a, 21b, 21c) may be located on or in a transition piece, or in the tower 4 of the wind turbine 1. To reduce transmission losses and realise as efficient a system as possible, the electrolyser(s) are preferably no more than 10 m from the generator 12 and more preferably no more than 5 m for the generator.

It will be clear to the skilled person that use of the described techniques are not limited to wind turbine blade testing and manufacture, or to composite part manufacture in general. The described techniques may be used in any application where it is desirable to automate processes requiring accurate positioning of a tool proximate a workpiece.

1. A wind turbine comprising:
a tower which supports a nacelle, wherein the nacelle supports a rotor assembly comprising a rotor hub and a plurality of rotor blades;
an electrical generator located in the nacelle, wherein the electrical generator is configured to be driven by the rotor assembly;
a rectifier electrically connected to the generator; and
a plurality of electrolysis cells arranged in one or more stacks, wherein each electrolysis cell comprises a pair of electrodes, and wherein each stack of electrolysis cells comprises at a plurality of electrical connectors each of which is in electrical contact with an electrode of an electrolysis cell,
wherein the electrical connectors are electrically connectable to the rectifier by a network of selectively operable electrical conductors which are configured so that some or all of the electrolysis cells are operable in dependence on the operative condition of the selectively operable electrical conductors.

2. The wind turbine according to claim 1, wherein the electrical connectors of at least one stack of electrolysis cells are configured so that electrical current may enter the stack at a plurality of locations.

3. The wind turbine according to claim 1, wherein the electrical connectors of at least one stack of electrolysis cells are configured so that electrical current may exit the stack at a plurality of locations.

4. The wind turbine according to claim 2, wherein two of the electrical connectors are connected by a bypass line so that electrical current may bypass at least one of the plurality of electrolysis cells arranged between the two electrical connectors.

5. The wind turbine according to claim 2, comprising a single stack of electrolysis cells.

6. The wind turbine according to claim 1, wherein the selective operability of the network of selectively operable electrical conductors is controlled by one or more switches.

7. The wind turbine according to claim 6, wherein the one or more switches are configured to be controlled by an electronic controller.

8. The wind turbine according to claim 1, comprising a stack of electrolysis cells located in the nacelle.

9. The wind turbine according to claim 1, comprising a stack of electrolysis cells located in the tower.

10. A method, comprising:
operating a wind turbine, comprising:
a tower which supports a nacelle, wherein the nacelle supports a rotor assembly comprising a rotor hub and a plurality of rotor blades;
an electrical generator located in the nacelle, wherein the electrical generator is configured to be driven by the rotor assembly;
a rectifier electrically connected to the generator; and
a plurality of electrolysis cells arranged in one or more stacks, wherein each electrolysis cell comprises a pair of electrodes, and wherein each stack of electrolysis cells comprises at a plurality of electrical connectors each of which is in electrical contact with an electrode of an electrolysis cell,
wherein the electrical connectors are electrically connectable to the rectifier by a network of selectively operable electrical conductors which are configured so that some or all of the electrolysis cells are operable in dependence on the operative condition of the selectively operable electrical conductors;
determining an output characteristic of the generator; and
controlling the operation of the selectively operable electrical conductors in dependence on the determined generator output characteristic in order to operate some or all of the electrolysis cells.

11. The method according to claim 10, comprising controlling the selectively operable electrical conductors to operate all of the electrolysis cells when the generator output characteristic meets or exceeds a predetermined criteria.

12. The method according to claim 10, comprising controlling the selectively operable electrical conductors so as to operate a first number of the electrolysis cells when the generator output characteristic meets or exceeds a first predetermined criteria, and controlling the selectively operable electrical conductors so as to operate a second number of the electrolysis cells when the generator output characteristic meets or exceeds a second predetermined criteria, wherein the second number of electrolysis cells is greater than the first number of electrolysis cells, and wherein the second predetermined criteria corresponds to a higher generator power output than the first predetermined criteria.

13. The method according to claim 10, comprising determining the total operational time for each electrolysis cell, or for a set of electrolysis cells, and operating a selection of the electrolysis cells based on an algorithm configured to preferentially operate electrolysis cells, or sets of electrolysis cells, with the lowest total operational time.

14. The method according to claim 10, comprising determining the internal resistance of each electrolysis cell, or for a set of electrolysis cells, and operating a selection of the electrolysis cells based on an algorithm configured to preferentially operate electrolysis cells, or sets of electrolysis cells, with the lowest internal resistance.

15. A wind turbine comprising:
a tower which supports a nacelle, wherein the nacelle supports a rotor assembly comprising a rotor hub and a plurality of rotor blades;
an electrical generator located in the nacelle, wherein the electrical generator is configured to be driven by the rotor assembly;
a rectifier electrically connected to the generator; and
a plurality of electrolysis cells arranged in one or more stacks, wherein each electrolysis cell comprises a pair of electrodes, and wherein each stack of electrolysis cells comprises at a plurality of electrical connectors each of which is in electrical contact with an electrode of an electrolysis cell,
wherein the electrical connectors are electrically connectable to the rectifier by a network of selectively operable electrical conductors which are configured so that some or all of the electrolysis cells are operable in dependence on the operative condition of the selectively operable electrical conductors,
wherein the electrical connectors of at least a first stack of electrolysis cells are configured so that electrical current may enter the stack at a plurality of locations,
wherein the electrical connectors of at least a second stack of electrolysis cells are configured so that electrical current may exit the stack at a plurality of locations.

16. The wind turbine according to claim 15, wherein two of the electrical connectors are connected by a bypass line so that electrical current may bypass at least one of the plurality of electrolysis cells arranged between the two electrical connectors.
